(19) United States
(12) Patent Application Publication
(10) Pub. No.: US 2016/0162507 A1
(43) Pub. Date: Jun. 9, 2016

(54) AUTOMATED DATA DUPLICATE IDENTIFICATION

(71) Applicant: INTERNATIONAL BUSINESS MACHINES CORPORATION, Armonk, NY (US)

(72) Inventors: Ritesh K. Gupta, Hyderabad (IN); Namit Kabra, Hyderabad (IN); Manish Kumar, Bangalore (IN); Srinivas K. Mittapalli, Secunderabad (IN)

(21) Appl. No.: 14/561,927

(22) Filed: Dec. 5, 2014

(51) Int. Cl. G06F 17/30

(52) U.S. Cl. CPC G06F 17/30156

(57) ABSTRACT

In an approach to identifying duplicates in data, one or more computer processors receive a request from a user to identify duplicates in a data set. The one or more computer processors retrieve the data set utilizing data discovery. The one or more computer processors perform data profiling on the data set. The one or more computer processors determine one or more domain types of the data set, based, at least in part, on the performed data profiling. The one or more computer processors perform data standardization on the data set, based, at least in part, on the one or more determined domain types. Responsive to performing data standardization, the one or more computer processors perform probabilistic matching on the data set. The one or more computer processors to identify two or more duplicates in the data set, based, at least in part, on the probabilistic matching.

### BACKGROUND OF THE INVENTION

The present invention relates generally to the field of data deduplication, and more particularly to automated identification of duplicate data.

Many organizations maintain extensive databases to track a variety of different types of data, for example, customer data, inventory data, etc. Having accurate, i.e., high quality, data is often of significant importance. One aspect of maintaining quality data relates to a process referred to as deduplication. Deduplication refers, in general, to the identification and elimination of duplicate records within a database. Duplicate records may be records that are not fully identical but represent the same entity. Using deduplication, organizations can significantly reduce data storage and get a single view of disparate data.

Data discovery is a business intelligence architecture aimed at interactive reports and explorable data from multiple sources. Data discovery can be defined as the detection of patterns in data. A data discovery software tool may have the ability to integrate multiple data sources, analyze data easily and quickly, and display data interactively.

Data profiling is a method of examining data available in a data source and collecting statistics and information about the data. Such statistics help to identify the use and quality of metadata. Data profiling clarifies the structure, relationship, content, and derivation rules of data, which aids in the understanding of anomalies within metadata.

Data standardization is the process of reaching agreement on common data definitions, formats, representation, and structures of all data layers and elements. For example, standardized data may display all names in the format “Surname, Given name,” all dates in the format “YYYY/MM/DD,” and all cities in the format “Name, 2-letter state abbreviation.”

### SUMMARY

Embodiments of the present invention disclose a method, a computer program product, and a system for identifying duplicates in data. The method may include one or more computer processors receiving a request from a user to identify duplicates in a data set. The one or more computer processors retrieve the data set utilizing data discovery. The one or more computer processors perform data profiling on the data set. The one or more computer processors determine one or more domain types of the data set, based, at least in part, on the performed data profiling. The one or more computer processors perform data standardization on the data set, based, at least in part, on the one or more determined domain types. After performing data standardization, the one or more computer processors perform probabilistic matching on the data set. The one or more computer processors to identify two or more duplicates in the data set, based, at least in part, on the probabilistic matching.

### BRIEF DESCRIPTION OF THE SEVERAL VIEWS OF THE DRAWINGS

FIG. 1 is a functional block diagram illustrating a distributed data processing environment, in accordance with an embodiment of the present invention;

FIG. 2 is a flowchart depicting operational steps of a duplicate identification program, on a server computer within the distributed data processing environment of FIG. 1, for identifying duplicate data records, in accordance with an embodiment of the present invention; and

FIG. 3 depicts a block diagram of components of the server computer executing the duplicate identification program within the distributed data processing environment of FIG. 1, in accordance with an embodiment of the present invention.

### DETAILED DESCRIPTION

Deduplication, i.e., removing duplicate data values in a data set, can be a complex and time consuming process. The deduplication process can include multiple steps such as finding and extracting relevant data, standardizing the data, creating a matching logic, and generating a report. Embodiments of the present invention recognize that efficiency can be gained with an automated method which performs multiple steps required for duplicate identification for a user. Implementation of embodiments of the invention may take a variety of forms, and exemplary implementation details are discussed subsequently with reference to the Figures.

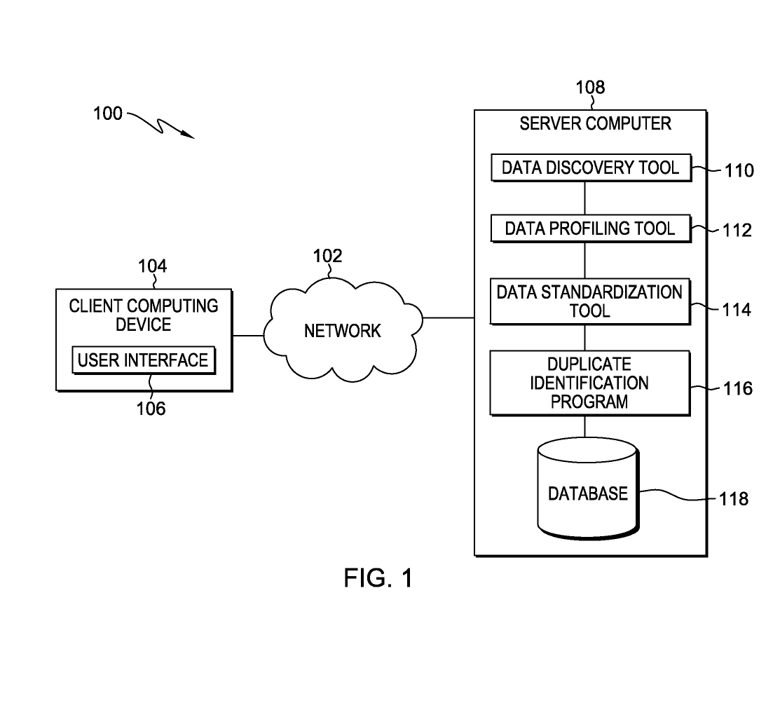

FIG. 1 is a functional block diagram illustrating a distributed data processing environment, generally designated 100, in accordance with one embodiment of the present invention. FIG. 1 provides only an illustration of one implementation and does not imply any limitations with regard to the environments in which different embodiments may be implemented. Many modifications to the depicted environment may be made by those skilled in the art without departing from the scope of the invention as recited by the claims.

Distributed data processing environment 100 includes client computing device 104 and server computer 108 interconnected over network 102. Network 102 can be, for example, a telecommunications network, a local area network (LAN), a wide area network (WAN), such as the Internet, or a combination of the three, and can include wired, wireless, or fiber optic connections. Network 102 can include one or more wired and/or wireless networks that are capable of receiving and transmitting data, voice, and/or video signals, including multimedia signals that include voice, data, and video information.

Client computing device 104 can be a desktop computer, a laptop computer, a tablet computer, a specialized computer server, a smart phone, or any programmable electronic device capable of communicating with server computer 108, via network 102, and with various components and devices within distributed data processing environment 100. In general, client computing device 104 represents any programmable electronic device or combination of programmable electronic devices capable of executing machine readable program instructions and communicating with other computing devices via a network, such as network 102. Client computing device 104 includes user interface 106.

User interface 106 provides an interface between a user of client computing device 104 and server computer 108. User interface 106 may be a graphical user interface (GUI) or a web user interface (WUI) and can display text, documents, web browser windows, user options, application interfaces, and instructions for operation, and includes the information (such as graphic, text, and sound) that a program presents to a user and the control sequences the user employs to control the program. User interface 106 may also be mobile application software that provides an interface between a user of client computing device 104 and server computer 108. Mobile application software, or an “app,” is a computer program designed to run on smart phones, tablet computers and other mobile devices. User interface 106 enables a user of client computing device 104 to request duplicate identification and receive results from server computer 108.

Server computer 108 can be a management server, a web server, or any other electronic device or computing system capable of receiving and sending data. In other embodiments, server computer 108 can represent a server computing system utilizing multiple computers as a server system, such as in a cloud computing environment. In another embodiment, server computer 108 can be a laptop computer, a tablet computer, a netbook computer, a personal computer (PC), a desktop computer, a personal digital assistant (PDA), a smart phone, or any programmable electronic device capable of communicating with client computing device 104 via network 102. In another embodiment, server computer 108 represents a computing system utilizing clustered computers and components to act as a single pool of seamless resources. Server computer 108 includes data discovery tool 110, data profiling tool 112, data standardization tool 114, duplicate identification program 116, and database 118.

Data discovery tool 110 resides on server computer 108. In another embodiment, data discovery tool 110 may reside elsewhere in distributed data processing environment 100 provided that duplicate identification program 116 can access data discovery tool 110 via network 102. A data discovery tool can find patterns, or relationships, that are too specific, and seemingly arbitrary, to specify. The data discovery tool can then present the patterns, and the location of the patterns, in the data to a user. If a user searches for duplicates in a database, such as database 118, then data discovery tool 110 can locate the search term and pull the relevant details related to the search term. For example, if a user searches for duplicates related to the term “customer,” then data discovery tool 110 can pull information related to “customer,” such as address, phone number, email address, etc. In another example, data discovery tool may also find patterns in a customer's purchasing history, such as always placing an order on the first of the month.

Data profiling tool 112 resides on server computer 108. In another embodiment, data profiling tool 112 may reside elsewhere in distributed data processing environment 100 provided that duplicate identification program 116 can access data profiling tool 112 via network 102. Data profiling software tools evaluate the actual content, structure and quality of the data by exploring relationships that exist between value collections both within and across data sets. For example, by examining how frequently different values occur in each column in a table, an analyst can gain insight into the type and use of each column.

Data standardization tool 114 resides on server computer 108. In another embodiment, data standardization tool 114 may reside elsewhere in distributed data processing environment 100 provided that duplicate identification program 116 can access data standardization tool 114 via network 102. Data standardization is a standard practice in data matching procedures. Standardizing the data improves the data quality. In one embodiment, data standardization tool 114 accomplishes data standardization through simple rule-based data transformations. In another embodiment, data standardization tool 114 may accomplish data standardization using more complex procedures such as lexicon-based tokenization and probabilistic hidden Markov models. Data standardization tool 114 fills in missing data values in a table based on the data values with the highest frequency using a lookup table. For example, the name “John” is generally associated with the gender “male.” If data standardization tool 114 finds a null value in the gender column of a table with a record that includes the name “John”, then data standardization tool 114 can fill in the value with “male” based on the high frequency of the association.

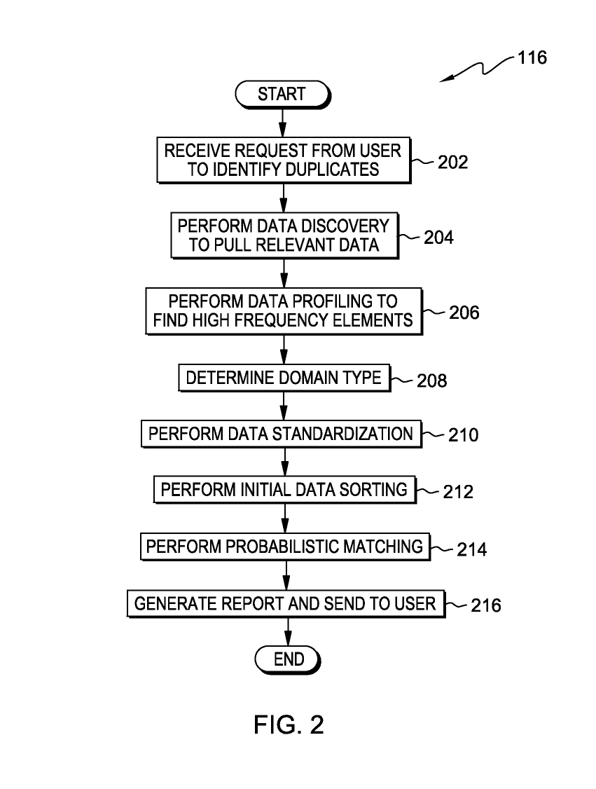

Duplicate identification program 116 is an end to end algorithm for automating the process of identifying duplicates in data. Duplicate identification program 116 integrates results that data discovery tool 110, data profiling tool 112, and data standardization tool 114 provide to identify duplicates in data and generate a report to present to the user. Duplicate identification program 116 receives a request from a user to identify duplicates for a specific data value. Duplicate identification program 116 triggers data discovery tool 110 to perform data discovery to pull the data relevant to the user's request. Automatically gathering the input using data discovery can identify input that may not be obvious in the initial input the user provides. Duplicate identification program 116 triggers data profiling tool 112 to find high frequency elements. Duplicate identification program 116 determines the domain of the data, i.e., what kind of data exists in the columns. Based on the domain, duplicate identification program 116 triggers data standardization tool 114 to standardize the data. Duplicate identification program 116 groups the data and performs probabilistic matching to identify the duplicates in the data. Duplicate identification program 116 generates a report that identifies the duplicates and sends the report to the user. Duplicate identification program 116 is depicted and described in further detail with respect to FIG. 2.

Database 118 resides on server computer 108. In another embodiment, database 118 can reside on client computing device 104 or elsewhere in the environment. A database is an organized collection of data. Database 118 can be implemented with any type of storage device capable of storing data that can be accessed and utilized by server computer 108, such as a database server, a hard disk drive, or a flash memory. In other embodiments, database 118 can represent multiple storage devices within server computer 108. Database 118 stores data used by an enterprise or organization to track a plurality of data types. Database 118 may also store various matching algorithms used by duplicate identification program 116.

FIG. 2 is a flowchart depicting operational steps of duplicate identification program 116, on server computer 108 within distributed data processing environment 100 of FIG. 1, for identifying duplicate data records, in accordance with an embodiment of the present invention.

Duplicate identification program 116 receives a request from a user to identify duplicates (step 202). A user sends a request for data duplication identification, via user interface 106, and duplicate identification program 116 receives the request. A user may request duplicate identification to reduce data storage by only storing one copy of a data value. A user may also request duplicate identification to determine whether multiple versions of the same entity exist in a database, such as database 118. For example, if a user has a mailing list for advertising, the user prefers to only send one copy of the advertisement per customer. If a mailing list includes duplicates of a customer's name, the user wastes time and resources sending more than one copy of the advertisement to one customer. In one embodiment, the user chooses a term or data value, such as the term “customer,” for which the user wants to find duplicates and clicks a button labeled “Find Duplicates,” via user interface 106, to initiate duplicate identification program 116 and send a request.

Duplicate identification program 116 performs data discovery to pull relevant data (step 204). As will be appreciated by one skilled in the art, data discovery offers easy exploration across a large variety of data to provide users with extensive new visibility into results such as business performance. In addition, instead of a lengthy process of specifying requirements for the system, data discovery allows rapid, intuitive exploration and analysis of information from any combination of sources. Duplicate identification program 116 triggers data discovery tool 110 to retrieve the relevant details of the data requested by the user to find hidden relationships within the data set. For example, if the user chooses the term “customer,” duplicate identification program 116 triggers data discovery tool 110 to find the location of customer data and pull the metadata associated with the customer data, such as address, phone number, email address, social security number, etc.

Duplicate identification program 116 performs data profiling to find high frequency elements (step 206). As will be appreciated by one skilled in the art, data profiling is the statistical analysis and assessment of the quality of data values within a data set for consistency, uniqueness and logic. Examples of data profiling techniques include, but are not limited to, frequency analysis, nullability check, frequency distribution data, data classification, and column analysis. Duplicate identification program 116 triggers data profiling tool 112 to find the most frequently occurring data values in each column of the data set. For example, duplicate identification program 116 determines the highest frequency element in one column is “13760” because 50% of the records include “13760,” while other high frequency elements in the column include “13850” in 20% of the records and “13802” in 15% of the records. In another example, duplicate identification program 116 determines the highest frequency element in one column is “Endicott” because 40% of the records include “Endicott,” while other high frequency elements in the column include “Vestal” in 15% of the records and “Binghamton” in 15% of the records.

Duplicate identification program 116 determines domain type (step 208). Determining the high frequency data elements in step 206 can indicate what aspect of the search term the data describes. Duplicate identification program 116 determines the domain of the data. For example, if a column includes high frequency values of “13760,” “13850,” and “13802,” then duplicate identification program 116 determines the domain of the data as “zip code.” In another example, if a column includes high frequency values of “Endicott,” “Vestal,” and “Binghamton,” then duplicate identification program 116 determines the domain of the data as “city.” In one embodiment, if duplicate identification program 116 cannot determine the domain type, then duplicate identification program 116 prompts the user, via user interface 106, to either classify the domain, instruct duplicate identification program 116 to ignore the data value, or instruct duplicate identification program 116 to include the data to compare to other values during a matching process.

Duplicate identification program 116 performs data standardization (step 210). Based on the determined data domain, duplicate identification program 116 triggers data standardization tool 114 to apply a proper standardization rule to the data to improve the data quality and fill in missing values. As will be appreciated by one skilled in the art, data standardization is a standard practice in data matching procedures. For example, if data standardization tool 114 finds a null value in the zip code column of a table with a record that includes the city “Endicott,” then data standardization tool 114 can fill in the value with “13760” based on the lookup table that exists for the domain.

Duplicate identification program 116 performs initial data sorting (step 212). In preparation for a data matching procedure, duplicate identification program 116 performs an initial sorting of the data to put the data in associated groups or categories. In one embodiment, duplicate identification program 116 uses a method that incorporates automatic selection of blocking columns to perform the initial data sorting. In data matching, a block can refer to a number of fields within a column set that have a same value. In a data set with more than one column, the number of blocks is the number of unique combinations of values joined by the “AND” operator. In another embodiment, duplicate identification program 116 may prompt the user, via user interface 106, to manually specify a blocking column based on previous domain knowledge.

Duplicate identification program 116 performs probabilistic matching (step 214). Probabilistic matching technology utilizes statistical analysis on data, and then applies the analysis to weight the match. Probabilistic matching takes into account a wider range of potential “identifiers,” i.e., different types of data records, by computing weights for each identifier based on its estimated ability to correctly identify a match or a non-match, and using these weights to calculate the probability that two given data records refer to the same entity. Duplicate identification program 116 performs probabilistic matching on the previously standardized and sorted data to identify duplicates in the data set. For example, there are two entries in a column called “customer name” as follows: “John Smith” and “Smith, John.” Data standardization transforms the two entries to have the same format, such as “John Smith.” Initial data sorting indicates that the two entries list the same number in a column called “social security number,” and groups the two entries together. Probabilistic matching identifies the similarity between the two data records and assigns a high weight to the probability that the two records are duplicates. Duplicate identification program 116 may choose a different probabilistic matching algorithm depending on the type of data being matched. For example, duplicate identification program 116 may choose an algorithm better suited to matching integers if the data values are integers.

Duplicate identification program 116 generates a report and sends the report to the user (step 216). Responsive to performing probabilistic matching and identifying duplicates in the data, duplicate identification program 116 generates a report of any duplicates found. In one embodiment, the report includes the input columns and two additional columns. One of the additional columns lists the weight of the match, as determined by the probabilistic matching algorithm used in step 214. The weight of the match indicates how much importance duplicate identification program 116 attributes to a match. Another additional column lists an identifier of a term in the master record and all of the duplicates of the term. In one embodiment, the identifier is called a cluster ID. For example, the identifier may be a particular number, and the additional column lists the particular number associated with the original data value in association with the duplicates of the original data value, therefore identifying a cluster of duplicate data values. After duplicate identification program 116 generates the report, duplicate identification program 116 sends the report to the user, via user interface 106. In one embodiment, duplicate identification program 116 sends the report to the user by displaying it on a computer screen. In another embodiment, duplicate identification program 116 may send the report to the user via email or text message, where the report may be in text format or in an attached file. In a further embodiment, duplicate identification program 116 may send the report to the user by sending a link to a social media or other web site to the user.

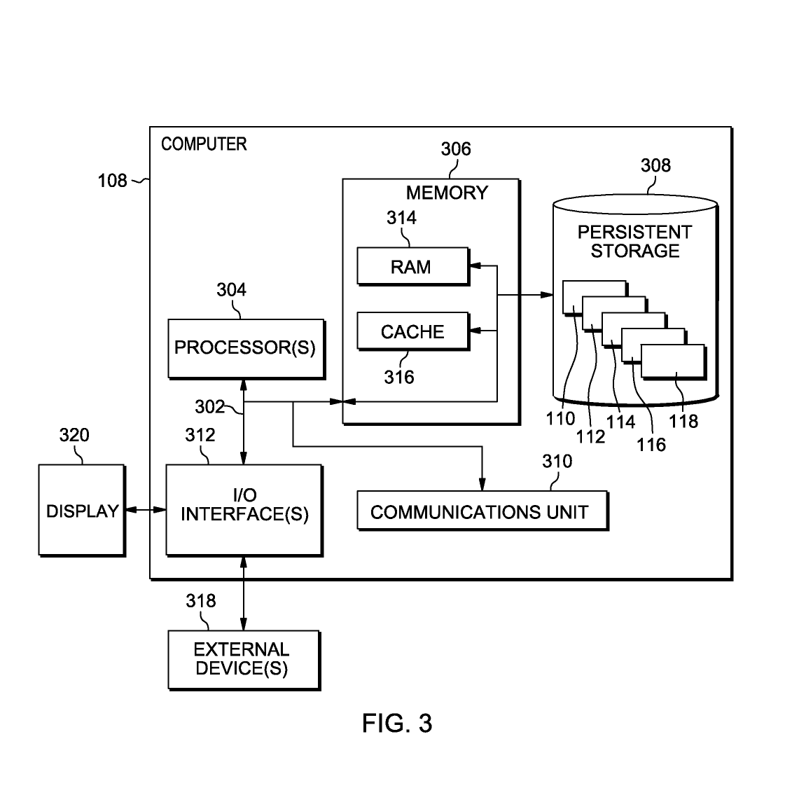

FIG. 3 depicts a block diagram of components of server computer 108 executing duplicate identification program 116 within distributed data processing environment 100 of FIG. 1, in accordance with an embodiment of the present invention. It should be appreciated that FIG. 3 provides only an illustration of one implementation and does not imply any limitations with regard to the environments in which different embodiments can be implemented. Many modifications to the depicted environment can be made.

Server computer 108 includes communications fabric 302, which provides communications between computer processor(s) 304, memory 306, persistent storage 308, communications unit 310, and input/output (I/O) interface(s) 312. Communications fabric 302 can be implemented with any architecture designed for passing data and/or control information between processors (such as microprocessors, communications and network processors, etc.), system memory, peripheral devices, and any other hardware components within a system. For example, communications fabric 302 can be implemented with one or more buses.

Memory 306 and persistent storage 308 are computer readable storage media. In this embodiment, memory 306 includes random access memory (RAM) 314 and cache memory 316. In general, memory 306 can include any suitable volatile or non-volatile computer readable storage media.

Data discovery tool 110, data profiling tool 112, data standardization tool 114, duplicate identification program 116, and database 118 are stored in persistent storage 308 for execution and/or access by one or more of the respective computer processor(s) 304 via one or more memories of memory 306. In this embodiment, persistent storage 308 includes a magnetic hard disk drive. Alternatively, or in addition to a magnetic hard disk drive, persistent storage 308 can include a solid-state hard drive, a semiconductor storage device, a read-only memory (ROM), an erasable programmable read-only memory (EPROM), a flash memory, or any other computer readable storage media that is capable of storing program instructions or digital information.

The media used by persistent storage 308 may also be removable. For example, a removable hard drive may be used for persistent storage 308. Other examples include optical and magnetic disks, thumb drives, and smart cards that are inserted into a drive for transfer onto another computer readable storage medium that is also part of persistent storage 308.

Communications unit 310, in these examples, provides for communications with other data processing systems or devices, including resources of client computing device 104. In these examples, communications unit 310 includes one or more network interface cards. Communications unit 310 may provide communications through the use of either or both physical and wireless communications links. Data discovery tool 110, data profiling tool 112, data standardization tool 114, duplicate identification program 116, and database 118 may be downloaded to persistent storage 308 through communications unit 310.

I/O interface(s) 312 allows for input and output of data with other devices that may be connected to server computer 108. For example, I/O interface(s) 312 may provide a connection to external device(s) 318 such as a keyboard, a keypad, a touch screen, a microphone, a digital camera, and/or some other suitable input device. External device(s) 318 can also include portable computer readable storage media such as, for example, thumb drives, portable optical or magnetic disks, and memory cards. Software and data used to practice embodiments of the present invention, e.g., data discovery tool 110, data profiling tool 112, data standardization tool 114, duplicate identification program 116, and database 118, can be stored on such portable computer readable storage media and can be loaded onto persistent storage 308 via I/O interface(s) 312. I/O interface(s) 312 also connect to a display 320.

Display 320 provides a mechanism to display data to a user and may be, for example, a computer monitor.

The programs described herein are identified based upon the application for which they are implemented in a specific embodiment of the invention. However, it should be appreciated that any particular program nomenclature herein is used merely for convenience, and thus the invention should not be limited to use solely in any specific application identified and/or implied by such nomenclature.

The present invention may be a system, a method, and/or a computer program product. The computer program product may include a computer readable storage medium (or media) having computer readable program instructions thereon for causing a processor to carry out aspects of the present invention.

The computer readable storage medium can be any tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, or either source code or object code written in any combination of one or more programming languages, including an object oriented programming language such as Smalltalk, C++ or the like, and conventional procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, a special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, a segment, or a portion of instructions, which comprises one or more executable instructions for implementing the specified logical function(s). In some alternative implementations, the functions noted in the blocks may occur out of the order noted in the Figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

The descriptions of the various embodiments of the present invention have been presented for purposes of illustration, but are not intended to be exhaustive or limited to the embodiments disclosed. Many modifications and variations will be apparent to those of ordinary skill in the art without departing from the scope and spirit of the invention. The terminology used herein was chosen to best explain the principles of the embodiment, the practical application or technical improvement over technologies found in the marketplace, or to enable others of ordinary skill in the art to understand the embodiments disclosed herein.

What is claimed is:

1. A method for identifying duplicates in a data set, the method comprising:
receiving, by one or more computer processors, a request from a user to identify duplicates in a data set;
retrieving, by the one or more computer processors, the data set utilizing data discovery;
performing, by the one or more computer processors, data profiling on the data set;
determining, by the one or more computer processors, one or more domain types of the data set, based, at least in part, on the performed data profiling;
performing, by the one or more computer processors, data standardization on the data set, based, at least in part, on the one or more determined domain types;
responsive to performing data standardization, performing, by the one or more computer processors, probabilistic matching on the data set; and
identifying, by the one or more computer processors, two or more duplicates in the data set, based, at least in part, on the probabilistic matching.

2. The method of claim 1, further comprising, responsive to performing data standardization on the data set, selecting, by the one or more computer processors, one or more blocking columns to sort data in the data set into a plurality of associated categories.

3. The method of claim 1, further comprising:
responsive to identifying two or more duplicates in the data set, generating a report of one or more identified duplicates in the data set; and
sending, by the one or more computer processors, the report to the user.

4. The method of claim 3, wherein the report of identified duplicates in the data set includes one or more of an input data set, a duplicate identifier, and a weight of a match.

5. The method of claim 1, wherein retrieving the data set utilizing data discovery further comprises identifying, by the one or more computer processors, one or more hidden relationships in the data set.

6. The method of claim 1, wherein performing data standardization further comprises:
selecting, by the one or more computer processors, a data standardization rule, based, at least in part, on the one or more determined domain types; and
applying, by the one or more computer processors, the data standardization rule to the data set.

7. The method of claim 1, wherein performing probabilistic matching further comprises:
calculating, by the one or more computer processors, one or more weights associated with one or more data values; and
calculating, by the one or more computer processors, based, at least in part on the calculated one or more weights, a probability that the one or more data values match.

8. A computer program product for identifying duplicates in data, the computer program product comprising:
one or more computer readable storage media and program instructions stored on the one or more computer readable storage media, the program instructions comprising:
program instructions to receive a request from a user to identify duplicates in a data set;
program instructions to retrieve the data set utilizing data discovery;
program instructions to perform data profiling on the data set;
program instructions to determine one or more domain types of the data set, based, at least in part, on the performed data profiling;
program instructions to perform data standardization on the data set, based, at least in part, on the one or more determined domain types;
responsive to performing data standardization, program instructions to perform probabilistic matching on the data set; and
program instructions to identify two or more duplicates in the data set, based, at least in part, on the probabilistic matching.

9. The computer program product of claim 8, further comprising, responsive to performing data standardization on the data set, program instructions to select one or more blocking columns to sort data in the data set into a plurality of associated categories.

10. The computer program product of claim 8, further comprising:
responsive to identifying two or more duplicates in the data set, generating a report of one or more identified duplicates in the data set; and sending, by the one or more computer processors, the report to the user.

11. The computer program product of claim 10, wherein the report of identified duplicates in the data set includes one or more of an input data set, a duplicate identifier, and a weight of a match.

12. The computer program product of claim 8, wherein retrieving the data set utilizing data discovery further comprises identifying, by the one or more computer processors, one or more hidden relationships in the data set.

13. The computer program product of claim 8, wherein performing data standardization further comprises:
selecting, by the one or more computer processors, a data standardization rule, based, at least in part, on the one or more determined domain types; and
applying, by the one or more computer processors, the data standardization rule to the data set.

14. The computer program product of claim 8, wherein performing probabilistic matching further comprises:
calculating, by the one or more computer processors, one or more weights associated with one or more data values; and
calculating, by the one or more computer processors, based, at least in part on the calculated one or more weights, a probability that the one or more data values match.

15. A computer system for identifying duplicates in data, the computer system comprising:
one or more computer processors;
one or more computer readable storage media;
program instructions stored on the one or more computer readable storage media for execution by at least one of the one or more computer processors, the program instructions comprising:
program instructions to receive a request from a user to identify duplicates in a data set;
program instructions to retrieve the data set utilizing data discovery;
program instructions to perform data profiling on the data set;
program instructions to determine one or more domain types of the data set, based, at least in part, on the performed data profiling;
program instructions to perform data standardization on the data set, based, at least in part, on the one or more determined domain types;
responsive to performing data standardization, program instructions to perform probabilistic matching on the data set; and
program instructions to identify two or more duplicates in the data set, based, at least in part, on the probabilistic matching.

16. The computer system of claim 15, further comprising, responsive to performing data standardization on the data set, program instructions to select one or more blocking columns to sort data in the data set into a plurality of associated categories.

17. The computer system of claim 15, further comprising:
responsive to identifying two or more duplicates in the data set, generating a report of one or more identified duplicates in the data set; and
sending, by the one or more computer processors, the report to the user.

18. The computer system of claim 17, wherein the report of identified duplicates in the data set includes one or more of an input data set, a duplicate identifier, and a weight of a match.

19. The computer system of claim 15, wherein retrieving the data set utilizing data discovery further comprises identifying, by the one or more computer processors, one or more hidden relationships in the data set.

20. The computer system of claim 15, wherein performing data standardization further comprises:
selecting, by the one or more computer processors, a data standardization rule, based, at least in part, on the one or more determined domain types; and
applying, by the one or more computer processors, the data standardization rule to the data set.
